(19) United States
(12) Patent Application Publication
(10) Pub. No.: US 2025/0119243 A1
(43) Pub. Date: Apr. 10, 2025

(54) SOFT BUFFER STATUS REPORTING

(71) Applicant: QUALCOMM Incorporated, San Diego, CA (US)

(72) Inventors: Jing SUN, San Diego, CA (US); Jing JIANG, San Diego, CA (US); Mostafa KHOSHNEVISAN, San Diego, CA (US); Junyi LI, Fairless Hills, PA (US); Yi HUANG, San Diego, CA (US); Kianoush HOSSEINI, San Diego, CA (US); Ahmed Abdelaziz Ibrahim Abdelaziz ZEWAIL, San Diego, CA (US)

(21) Appl. No.: 18/481,144

(22) Filed: Oct. 4, 2023

(51) Int. Cl. H04L 1/1829; H04L 1/08

(52) U.S. Cl. CPC H04L 1/1835; H04L 1/08

(57) ABSTRACT

Methods, systems, and devices for wireless communication are described. A user equipment (UE) may perform a decoding operation on a downlink message for the UE. The UE may store, in a buffer of the UE, decoding information associated with the decoding operation on the downlink message based at least in part on the decoding operation on the downlink message being at least partially unsuccessful. In some examples, the UE may transmit, to a network entity, a report indicating buffer usage information of the buffer of the UE, where the buffer usage information indicates one or more parameters associated with the decoding information stored in the buffer of the UE. In some cases, the buffer usage information may indicate one or more transport blocks for which entries are present in the buffer of the UE.

### FIELD OF TECHNOLOGY

The following relates to wireless communication, including soft buffer status reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support soft buffer status reporting. For example, the described techniques enable a UE to perform a decoding operation on a downlink message for the UE. The UE may store, in a buffer of the UE, decoding information associated with the decoding operation on the downlink message if the decoding operation is at least partially unsuccessful. In some examples, the UE may transmit a report indicating buffer usage information of the buffer of the UE. The buffer usage information may indicate parameters of the decoding information stored in the buffer of the UE. For example, the buffer usage information may indicate one or more transport blocks for which entries are present in the buffer of the UE.

A method by a UE is described. The method may include performing a decoding operation on a downlink message for the UE, storing, in a buffer of the UE, decoding information associated with the decoding operation on the downlink message based on the decoding operation on the downlink message being at least partially unsuccessful, and transmitting, to the network entity, a report indicating buffer usage information of the buffer of the UE, where the buffer usage information indicates one or more parameters associated with the decoding information stored in the buffer of the UE.

A UE is described. The UE may include one or more memories storing processor executable code, a transceiver, and one or more processors of the UE coupled with the transceiver and the one or more memories. The one or more processors may individually or collectively operable to execute the code to cause the UE to perform a decoding operation on a downlink message for the UE, store, in a buffer of the UE, decoding information associated with the decoding operation on the downlink message based on the decoding operation on the downlink message being at least partially unsuccessful, and transmit, to the network entity, a report indicating buffer usage information of the buffer of the UE, where the buffer usage information indicates one or more parameters associated with the decoding information stored in the buffer of the UE.

Another UE is described. The UE may include means for performing a decoding operation on a downlink message for the UE, means for storing, in a buffer of the UE, decoding information associated with the decoding operation on the downlink message based on the decoding operation on the downlink message being at least partially unsuccessful, and means for transmitting, to the network entity, a report indicating buffer usage information of the buffer of the UE, where the buffer usage information indicates one or more parameters associated with the decoding information stored in the buffer of the UE.

A non-transitory computer-readable medium storing code is described. The code may include instructions executable by a processor to perform a decoding operation on a downlink message for the UE, store, in a buffer of the UE, decoding information associated with the decoding operation on the downlink message based on the decoding operation on the downlink message being at least partially unsuccessful, and transmit, to the network entity, a report indicating buffer usage information of the buffer of the UE, where the buffer usage information indicates one or more parameters associated with the decoding information stored in the buffer of the UE.

In some examples of the method, UEs, and non-transitory computer-readable medium described herein, and the method, apparatuses, and non-transitory computer-readable medium may include further operations, features, means, or instructions for receiving a retransmission of the downlink message based on the report and performing a second decoding operation on the retransmission based on the one or more log-likelihood ratios (LLRs).

Some examples of the method, UEs, and non-transitory computer-readable medium described herein may further include operations, features, means, or instructions for receiving, from the network entity, a message indicating a periodic set of time resources for transmission of the report in accordance with a periodicity.

In some examples of the method, UEs, and non-transitory computer-readable medium described herein, transmitting the report may include operations, features, means, or instructions for transmitting the report via one or more time resources of the periodic set of time resources in accordance with the periodicity.

Some examples of the method, UEs, and non-transitory computer-readable medium described herein may further include operations, features, means, or instructions for refraining from transmitting a second report via one or more time resources of the periodic set of time resources based on the buffer usage information being the same as buffer usage information included in a previous report, a utilization of the buffer being below a threshold value, the buffer being empty, or a combination thereof.

Some examples of the method, UEs, and non-transitory computer-readable medium described herein may further include operations, features, means, or instructions for receiving, from the network entity, a message including one or more downlink control information bits, where the one or more downlink control information bits trigger the UE to transmit the report.

In some examples of the method, UEs, and non-transitory computer-readable medium described herein, the one or more downlink control information bits indicate one or more priority values, one or more component carriers, or a combination thereof, associated with buffer usage information to be included in the report.

Some examples of the method, UEs, and non-transitory computer-readable medium described herein may further include operations, features, means, or instructions for detecting an event at the UE, where the report may be transmitted based on detection of the event by the UE.

In some examples of the method, UEs, and non-transitory computer-readable medium described herein, detecting the event may include operations, features, means, or instructions for detecting an absence of a downlink control information transmission from the network entity.

In some examples of the method, UEs, and non-transitory computer-readable medium described herein, transmitting the report may include operations, features, means, or instructions for transmitting the report based on a buffer usage satisfying a threshold value, where the event includes the buffer usage satisfying the threshold value.

In some examples of the method, UEs, and non-transitory computer-readable medium described herein, the one or more parameters indicate a transport block associated with the decoding information stored in the buffer.

In some examples of the method, UEs, and non-transitory computer-readable medium described herein, the one or more parameters include an indication of a carrier identification value, a hybrid automatic repeat request identification value, a new data indication associated with the downlink message, or a combination thereof.

Some examples of the method, UEs, and non-transitory computer-readable medium described herein may further include operations, features, means, or instructions for storing, in the buffer of the UE, additional decoding information associated with a set of multiple decoding operations for a respective set of multiple downlink messages, each of the set of multiple decoding operations being at least partially unsuccessful.

Some examples of the method, UEs, and non-transitory computer-readable medium described herein may further include operations, features, means, or instructions for transmitting the report indicating the buffer usage information, where the buffer usage information indicates one or more parameters of the decoding information associated with the set of multiple decoding operations.

In some examples of the method, UEs, and non-transitory computer-readable medium described herein, the buffer usage information includes a respective bitmap for each component carrier of a set of component carriers associated with the set of multiple downlink messages, each respective bit of a first bitmap for a first component carrier of the set of component carriers indicating whether decoding information associated with a respective transport block for a respective downlink message of the set of multiple downlink messages may be stored in the buffer.

In some examples of the method, UEs, and non-transitory computer-readable medium described herein, the buffer usage information indicates a time instance, the time instance indicating that decoding information associated with downlink messages transmitted after the time instance may be stored in the buffer and decoding information associated with at least one downlink message transmitted before the time instance may be purged from the buffer.

In some examples of the method, UEs, and non-transitory computer-readable medium described herein, the report may be transmitted via an uplink control information message. In some examples of the method, UEs, and non-transitory computer-readable medium described herein, the report may be transmitted via a medium access control (MAC) control element (MAC-CE) message.

Some examples of the method, UEs, and non-transitory computer-readable medium described herein may further include operations, features, means, or instructions for transmitting a first uplink control information message indicating a size of the report and transmitting a second uplink control information message including the report.

A method by a network entity is described. The method may include transmitting a downlink message to a UE, receiving, from the UE, a report indicating buffer usage information of a buffer of the UE, where the buffer usage information indicates one or more parameters of decoding information associated with at least a partially unsuccessful decoding operation of the downlink message at the UE, and transmitting a retransmission of the downlink message based on receiving the report.

A network entity is described. The network entity may include one or more memories storing processor executable code, and one or more processors of the network entity coupled with the one or more memories. The one or more processors may individually or collectively operable to execute the code to cause the network entity to transmit a downlink message to a UE, receive, from the UE, a report indicating buffer usage information of a buffer of the UE, where the buffer usage information indicates one or more parameters of decoding information associated with at least a partially unsuccessful decoding operation of the downlink message at the UE, and transmit a retransmission of the downlink message based on receiving the report.

Another network entity is described. The network entity may include means for transmitting a downlink message to a UE, means for receiving, from the UE, a report indicating buffer usage information of a buffer of the UE, where the buffer usage information indicates one or more parameters of decoding information associated with at least a partially unsuccessful decoding operation of the downlink message at the UE, and means for transmitting a retransmission of the downlink message based on receiving the report.

A non-transitory computer-readable medium storing code is described. The code may include instructions executable by a processor to transmit a downlink message to a UE, receive, from the UE, a report indicating buffer usage information of a buffer of the UE, where the buffer usage information indicates one or more parameters of decoding information associated with at least a partially unsuccessful decoding operation of the downlink message at the UE, and transmit a retransmission of the downlink message based on receiving the report. In some examples of the method, network entities, and non-transitory computer-readable medium described herein, the decoding information includes one or more LLRs for a transport block associated with the downlink message.

Some examples of the method, network entities, and non-transitory computer-readable medium described herein may further include operations, features, means, or instructions for transmitting a message indicating a periodic set of time resources for transmission of the report by the UE in accordance with a periodicity, where the report may be received via a one or more resources of the periodic set of time resources in accordance with the periodicity.

Some examples of the method, network entities, and non-transitory computer-readable medium described herein may further include operations, features, means, or instructions for transmitting a message including one or more downlink control information bits, where the one or more downlink control information bits trigger the UE to transmit the report.

In some examples of the method, network entities, and non-transitory computer-readable medium described herein, the one or more downlink control information bits indicate one or more priority values, one or more component carriers, or a combination thereof, associated with buffer usage information to be included in the report.

In some examples of the method, network entities, and non-transitory computer-readable medium described herein, the one or more parameters indicate a transport block associated with the decoding information stored in the buffer.

In some examples of the method, network entities, and non-transitory computer-readable medium described herein, the one or more parameters include an indication of a carrier identification value, a hybrid automatic repeat request identification value, a new data indication associated with the downlink message, or a combination thereof.

In some examples of the method, network entities, and non-transitory computer-readable medium described herein, receiving the report may include operations, features, means, or instructions for receiving the report indicating the buffer usage information, where the buffer usage information indicates one or more parameters of additional decoding information associated with a set of multiple decoding operations corresponding to a set of multiple downlink messages, each of the set of multiple decoding operations being at least partially unsuccessful.

In some examples of the method, network entities, and non-transitory computer-readable medium described herein, the buffer usage information includes a respective bitmap for each component carrier of a set of component carriers associated with the set of multiple downlink messages, each respective bit of a first bitmap for a first component carrier of the set of component carriers indicating whether decoding information associated with a respective transport block for a respective downlink message of the set of multiple downlink messages may be stored in the buffer.

In some examples of the method, network entities, and non-transitory computer-readable medium described herein, the buffer usage information indicates a time instance, the time instance indicating that decoding information associated with downlink messages transmitted after the time instance may be stored in the buffer and decoding information associated with at least one downlink message transmitted before the time instance may be purged from the buffer.

In some examples of the method, network entities, and non-transitory computer-readable medium described herein, the report may be received via an uplink control information message. In some examples of the method, network entities, and non-transitory computer-readable medium described herein, the report may be transmitted via a MAC-CE message.

Some examples of the method, network entities, and non-transitory computer-readable medium described herein may further include operations, features, means, or instructions for receiving a first uplink control information message indicating a size of the report and receiving a second uplink control information message including the report.

### BRIEF DESCRIPTION OF THE DRAWINGS

FIG. 1 shows an example of a wireless communications system that supports soft buffer status reporting in accordance with one or more aspects of the present disclosure.

FIG. 2 shows an example of a wireless communications system that supports soft buffer status reporting in accordance with one or more aspects of the present disclosure.

FIG. 3 shows an example of a process flow that supports soft buffer status reporting in accordance with one or more aspects of the present disclosure.

FIGS. 4 and 5 show block diagrams of devices that support soft buffer status reporting in accordance with one or more aspects of the present disclosure.

FIG. 6 shows a block diagram of a communications manager that supports soft buffer status reporting in accordance with one or more aspects of the present disclosure.

FIG. 7 shows a diagram of a system including a device that supports soft buffer status reporting in accordance with one or more aspects of the present disclosure.

FIGS. 8 and 9 show block diagrams of devices that support soft buffer status reporting in accordance with one or more aspects of the present disclosure.

FIG. 10 shows a block diagram of a communications manager that supports soft buffer status reporting in accordance with one or more aspects of the present disclosure.

FIG. 11 shows a diagram of a system including a device that supports soft buffer status reporting in accordance with one or more aspects of the present disclosure.

FIGS. 12 through 15 show flowcharts illustrating methods that support soft buffer status reporting in accordance with one or more aspects of the present disclosure.

### DETAILED DESCRIPTION

A UE may decode a downlink message from a network entity by determining LLRs of a transport block carried by the downlink message. In some cases, however, a decoding operation may be unsuccessful (e.g., at least partially). In these cases, the UE may store decoding information (e.g., the LLRs) associated with the decoding operation in a buffer (e.g., a soft buffer) of the UE. The UE may use the decoding information in a decoding operation for a retransmission of the downlink message (e.g., for performing soft combining), thereby reducing computations and power consumption at the UE and improving network efficiency and use of resources. A network entity may generally keep track of decoding information stored by the UE in the buffer. For instance, the network entity may receive a negative acknowledgment (NACK) from the UE corresponding to an unsuccessful decoding operation for a downlink message, and the network entity may determine that the UE stored decoding information associated with the downlink message that was unsuccessfully decoded. In some cases, however, there may be a mismatch between the decoding information stored in the buffer of the UE and the decoding information that the network entity tracks as being stored in the buffer of the UE. For instance, as the buffer may be limited in capacity, the UE may purge (e.g., delete, remove) older entries in the buffer, but the network entity may estimate that purged entries are still present in the buffer. As such, techniques for the UE and the network entity to align on a current usage status of the buffer may be beneficial.

In accordance with examples as described herein, the UE may transmit a report indicating buffer usage information of the UE to the network entity. In some examples, the UE may transmit an indication of transport blocks for which entries are stored in the buffer, for example, by transmitting one or more bitmaps. For example, each respective bit of a bitmap may indicate whether a respective transport block is associated with an entry stored in the buffer, whether the respective transport block is associated with a new data indicator (NDI), or both. In some other examples, the UE may report a list of one or more entries stored in the buffer, and the list may include one or more carrier identifiers (IDs), HARQ IDs, NDIs, or a combination thereof, to indicate one or more transport block associated with a respective entry stored in the buffer. In some other examples, the UE may report an indication of a time instance associated with a latest purging operation. For example, the report may indicate that transport blocks transmitted prior to the time instance are not associated with an entry in the buffer (e.g., the entries have been purged), while transport blocks transmitted after the time instance are associated with an entry in the buffer. Accordingly, the network entity may perform retransmissions of downlink messages in accordance with the updated buffer usage information reported by the UE, which may support more efficient communications between the network entity and the UE and may help prevent failed retransmissions due to a misalignment between the network entity and the UE as to the information contained in the buffer of the UE.

Aspects of the disclosure are initially described in the context of wireless communications systems. Aspects of the disclosure are additionally illustrated and descried with respect to process flows. Aspects of the disclosure are further illustrated by and described with reference to apparatus diagrams, system diagrams, and flowcharts that relate to soft buffer status reporting.

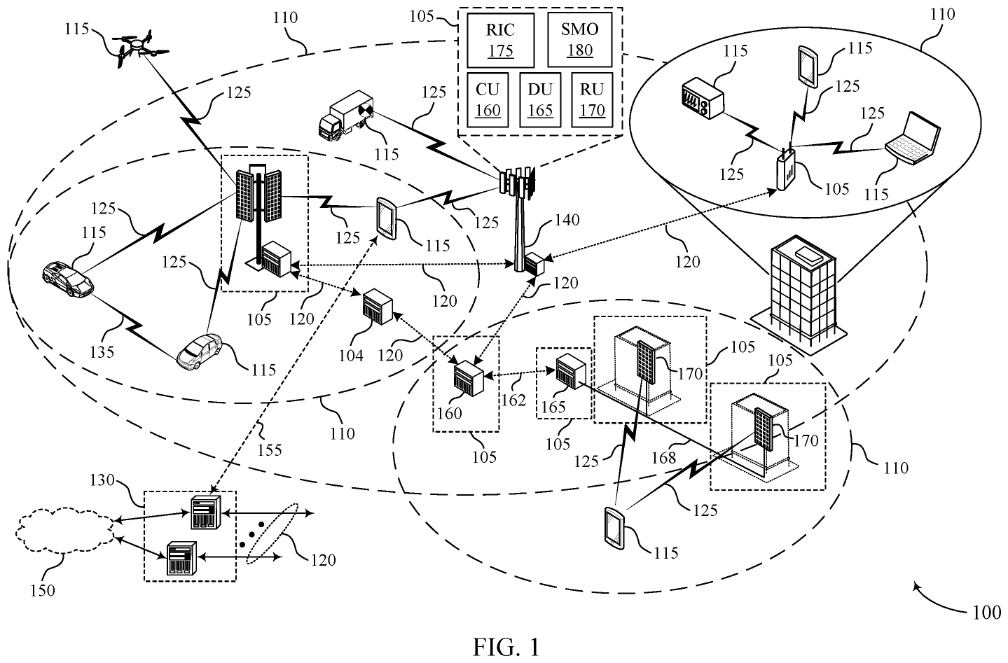

FIG. 1 shows an example of a wireless communications system 100 that supports soft buffer status reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support soft buffer status reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). HARQ feedback may involve a UE 115 transmitting an acknowledgment (ACK) to a network entity 105 to indicate successful reception and decoding of a downlink message, or a NACK to indicate unsuccessful reception or decoding of a downlink message. In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, to decode (e.g., using soft decoding techniques) a downlink message from a network entity 105, a UE 115 may calculate one or more LLRs (e.g., soft values), which may indicate a likelihood of one or more bits associated with the downlink message having a value (e.g., a value of one or zero). In some cases, however, a decoding operation by the UE 115 may be at least partially unsuccessful. In these cases, the UE 115 may store, in a buffer (e.g., a soft buffer) of the UE 115, calculated LLRs for a downlink transport block associated with the downlink message, such that the UE 115 may use soft combining in decoding operations for a retransmission of the downlink message. The buffer of the UE 115, which may be or include a memory, may have a limited capacity for storage. In some examples, the memory may be powered off for power savings, which may remove content stored in the buffer. In some cases, the quantity of soft buffer entries (e.g., pages) may be less than a quantity of HARQ processes that the network entity 105 and the UE 115 can use. The network entity 105 may generally keep track of decoding information stored by the UE 115 in the buffer. For instance, the network entity 105 may receive a NACK from the UE 115 corresponding to an unsuccessful decoding operation for a downlink message, and the network entity 105 may determine that the UE 115 stored decoding information associated with the downlink message.

In some cases, however, there may be a mismatch between the decoding information stored in the buffer of the UE 115 and the decoding information that the network entity estimates to be stored in the buffer of the UE 115. For example, as the buffer may be limited in capacity, the UE 115 may purge (e.g., erase, drop) older entries in the buffer, or the UE 115 may delete entries in the buffer if the memory is powered off (e.g., for power savings, or when the UE 115 powers off). Additionally, or alternatively, if the quantity of soft buffer entries is lower than a quantity of HARQ processes in use between the UE 115 and the network entity 105, the buffer of the UE 115 may not have the capacity to store decoding information for all the HARQ processes. Further, in some cases, the UE 115 may report a single ACK or NACK corresponding to a transport block, but the UE 115 may store decoding information in the buffer at a code block level. As such, the UE 115 may not have decoding information stored for each code block of a transport block, but the network entity 105 may be unaware of which code blocks have corresponding decoding information stored in the buffer. Additionally, or alternatively, some events (e.g., error events such as failed decoding, failed reception) and reporting of the error events by the UE 115 may be associated with delays.

As such, for one or more of these reasons, the network entity 105 may have outdated or incorrect information about the entries in the buffer of the UE 115, which may lead to errors when performing retransmissions of a downlink message. For instance, the network entity 105 may rely on LLRs being stored in the buffer by the UE 115 for the UE 115 to successfully decode of a message (e.g., by altering a puncturing scheme), but if the LLRs are not being stored, this may lead to failed decoding by the UE 115. Accordingly, techniques for the UE 115 and the network entity 105 to align on a current usage status of the buffer may be beneficial.

In accordance with examples as described herein, the UE 115 may report a buffer usage information (e.g., a buffer status of a buffer of the UE 115, parameters associated with the buffer of the UE 115) to the network entity 105. In some examples, the UE 115 may transmit an indication of transport blocks that have entries stored in the buffer, for example, by transmitting one or more bitmaps. For example, the UE 115 may report whether each transport block is associated with an entry stored in the buffer, whether each transport block is associated with an NDI, or both. In some other examples, the UE 115 may report a list of one or more entries stored in the buffer, and the list may include one or more carrier IDs, HARQ IDs, NDIs, or a combination thereof, to indicate one or more transport block associated with a respective entry stored in the buffer. In some other examples, the UE 115 may report an indication of a time instance associated with a latest purging operation, which may indicate that transport blocks transmitted prior to the time instance are not associated with an entry in the buffer (e.g., that the corresponding entries have been purged), while transport blocks transmitted after the time instance are associated with an entry in the buffer. Accordingly, estimated buffer usage information by the network entity 105 may be aligned (e.g., synced) based on the report from the UE 115, and the network entity 105 may perform retransmissions of downlink messages in accordance with the updated buffer usage information reported by the UE 115.

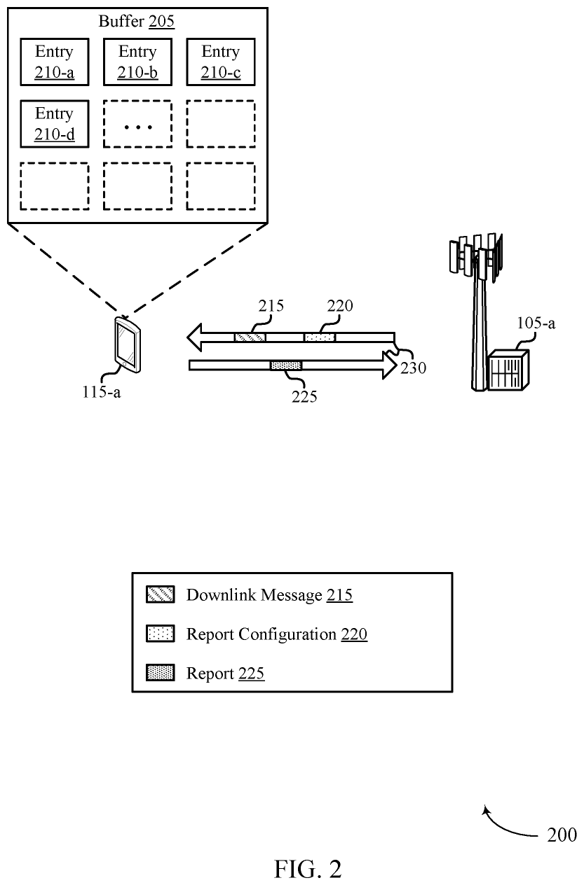

FIG. 2 shows an example of a wireless communications system 200 that supports soft buffer status reporting in accordance with one or more aspects of the present disclosure. The wireless communications system 200 may include a UE 115-a and a network entity 105-a, which may be examples of corresponding devices as described herein, with reference to FIG. 1. The UE 115-a and the network entity 105-a may communicate via one or more communication links 230, which may be examples of communication links 125 as described herein, e.g., with reference to FIG. 1.

In some examples, the UE 115-a may perform a decoding operation to decode a downlink message 215 received from the network entity 105-a. For example, the UE 115-a may calculate one or more LLRs (e.g., soft values), which may indicate a likelihood of one or more bits associated with the downlink message having a value (e.g., a value of ‘1’ or ‘0’). In some cases, however, a decoding operation by the UE 115-a may be at least partially unsuccessful. In these cases, the UE 115-a may store decoding information in an entry 210 of a buffer 205 (e.g., a memory) of the UE 115-a. For example, the UE 115-a may store decoding information in an entry 210-d for an unsuccessful decoding of the downlink message 215, and the decoding information may include calculated LLRs for a downlink transport block associated with the downlink message, an indication of the transport block, whether the transport block was associated with an NDI (e.g., whether the transport block included new data), a HARQ ID or redundancy version (RV), a carrier ID, or other parameters associated with the downlink message 215. The UE 115-a may receive a retransmission of the downlink message 215, and the UE 115-a may use soft combining to decode the retransmission, which may reduce operations (e.g., computations) performed by the UE 115-a and reduce power consumption.

The network entity 105-a may estimate which transport blocks are associated with entries 210 stored in the buffer 205. For example, the UE 115-a may report a NACK to the network entity 105-a in response to a decoding operation corresponding to a transport block for the downlink message 215 being (e.g., at least partially) unsuccessful, and the network entity 105-a may update the estimation of which transport blocks are associated with entries 210 in the buffer 205. As such, the network entity 105-a may perform retransmissions in accordance with entries 210 estimated to be stored in the buffer 205. In some examples, if the network entity 105-a determines (e.g., estimates) that the buffer 205 does not contain decoding information associated with a transport block of a downlink message 215, the network entity 105-a may perform a retransmission for the downlink message using a RV identifier (RVID) with a value of zero, which may indicate a systematic base for decoding by the UE 115-a (e.g., a base for low-density parity-check (LDPC) code). Additionally, or alternatively, the network entity 105-a may form a new transport block for the retransmission using different formatting, which may include a different quantity of bits as the original transport block, different information, or different parameters. Alternatively, if the network entity 105-a determines that the buffer 205 does contain decoding information associated with the transport block of the downlink message 215, the network entity 105-a may transmit the retransmission using the same transport block, the network entity 105-a may apply different puncturing patterns, or both, for example.

In some cases, however, the estimation of the network entity 105-a may be incorrect or outdated. For example, the buffer of the UE 115-a may have a limited capacity for storage (e.g., a quantity of entries 210), and the UE 115-a may perform a purging operation if the buffer 205 is at or above a threshold capacity or if the buffer 205 is full (e.g., at capacity). For instance, the UE 115-a may remove one or more entries 210 from the buffer, and the UE 115-a may delete oldest entries first (e.g., the entry 210-a). Additionally, or alternatively, the UE 115-a may choose to not maintain entries 210 of the buffer 205 after powering down the buffer 205 or the UE 115-a, and the network entity 105-a may not be aware that the entries 210 have been deleted. In some cases, there may be a delay between an unsuccessful decoding operation and the network entity 105-a receiving a report of an error event (e.g., via a NACK), which may cause the estimation of the buffer usage by the network entity 105-a to be outdated. Further, the UE 115-a may maintain entries 210 at a code block level, which may be a smaller (e.g., more precise) unit relative to transport blocks (e.g., multiple code blocks may be in one transport block), but the UE 115-a may report ACK/NACK feedback at a transport block level. As such, the network entity 105-a may be unaware of which code blocks are associated with entries in the buffer 205, even if the network entity 105-a receives a NACK for a transport block from the UE 115-a. Accordingly, techniques for the UE 115-a and the network entity 105-a to align on a current usage status of the buffer may reduce the discrepancy of the buffer usage between the UE 115-a and the network entity 105-a.

In accordance with examples as described herein, the UE 115-a may transmit a report 225 indicating buffer usage information (e.g., a buffer status) to the network entity 105-a. The buffer usage information may indicate which transport blocks are associated with entries 210 stored in the buffer 205 to the network entity 105-a. Additionally, or alternatively, such as when the UE 115-a stores decoding information in a code block or code block group basis, the UE 115-a may indicate which code blocks or code block groups are associated with entries 210 stored in the buffer 205. Accordingly, the network entity 105-a may maintain updated information regarding which transport blocks, code blocks, or code block groups are associated with entries 210 in the buffer 205, and the network entity 105-a may schedule retransmissions (e.g., select a transport block and an RVID) based on the updated information.

In some examples, the UE 115-a may transmit the report 225 via uplink control information. For example, the UE 115-a may transmit the report 225 using a fixed size, and the UE 115-a may multiplex the uplink control information with other uplink control information to be transmitted to the network entity 105-a. In some cases, such as if the report 225 has a variable size, the UE 115-a may transmit a two-part message (e.g., two-part uplink control information), where a first message may indicate a size of the report 225, and a second message may include the report 225. In some other examples, the UE 115-a may transmit the report 225 via a MAC-CE message, or via an physical uplink shared channel (PUSCH) message, such as a configured grant PUSCH.

In some examples, there may be a time delay between when the UE 115-a transmits the report 225 and when the network entity 105-a decodes the report 225 (e.g., a message containing the report 225) and parses the information contained in the report 225. As such, some information in the report 225 at the time the UE 115-a generates the report may be outdated after the time delay. To reduce the likelihood of outdated information, the UE 115-a may consider the time delay when generating the report 225. For instance, if the UE 115-a determines that a purge operation may be performed soon (e.g., if the buffer is at or above a threshold capacity), the UE 115-a may exclude one or more entries 210 (e.g., beginning from the oldest entry 210) from the report 225 as these may be purged by the time the network entity 105-a decodes and parses the report 225. In some cases, the network entity 105-a may indicate the UE 115-a of the time delay, which may increase the accuracy of reports 225.

In some examples, the UE 115-a may receive a report configuration 220 from the network entity 150-a. In some cases, the report configuration 220 may be indicated via RRC or may be semi-statically configured to the UE 115-a by the network entity 105-a. The report configuration 220 may indicate a set of one or more periodic resources (e.g., time resources, frequency resources), for example, by indicating a periodicity, an offset (e.g., time offset, frequency offset), a frequency location, or a combination thereof. Accordingly, the UE 115-a may periodically transmit a report 225 during each periodic resource in accordance with the report configuration 220 (e.g., in accordance with a configured periodicity and offset).

In some cases, the UE 115-a may skip (e.g., refrain from transmitting a report 225 during) one or more periodic resources of the set of periodic resources. For example, the UE 115-a may be subject to (e.g., configured with) one or more rules for skipping a periodic resource. In some examples, the UE 115-a may skip transmission of a report 225 if, for a UCI or configured grant PUSCH, there is no other information to transmit (e.g., to multiplex with), thereby reducing interference to other transmissions (e.g., by other UEs 115). Additionally, or alternatively, if the buffer 205 is empty (e.g., has no entries 210), or if the buffer usage information has not changed since a last report 225, the UE 115-a may skip transmission of the report 225. In some cases, if the buffer 205 is relatively empty (e.g., if a quantity of entries 210 in the buffer 205 is at or below a threshold value), the estimated buffer usage information by the network entity 105-a may be more likely to be accurate (e.g., as the UE 115-a likely has not performed purging operations). As such, the UE 115-a may refrain from transmitting a report 225 (e.g., during a configured periodic occasion) if the buffer 205 is relatively empty.

In some examples, the network entity 105-a may trigger the UE 115-a to transmit a report 225 (e.g., instead of configuring periodic resources). For example, the network entity 105-a may include one or more bits in downlink control information that may trigger the UE 115-a to transmit the report 225. The UE 115-a may include the report 225 in an uplink transmission (e.g., in standalone UCI or multiplexed with other UCI) in response to the trigger. In some examples, the one or more bits may indicate a type of report 225 to be transmitted by the UE 115-a. For example, one or more types of report may be defined which may include different information, such as a report 225 that includes buffer usage information associated with a specific priority of downlink messages (e.g., high priority transmissions, low priority transmissions, all transmission), a report 225 associated with one or more component carriers associated with (e.g., assigned to) the UE 115-a, a quantity of entries to be included in the report 225, the information to be included for each entry in the report 225, or other types of reports 225.

In some examples, the UE 115-a may be triggered to transmit a report 225 (e.g., aperiodically) based on one or more conditions. For example, the UE 115-a may be triggered to transmit a report 225 based on an event occurring that may cause the network entity 105-a to be misaligned on the information that is stored in the buffer 205. For example, the UE 115-a may determine an error event, such as an absence of a downlink control information transmission or code block transmission expected to be transmitted by the network entity 105-a, which may trigger the UE 115-a to transmit a report 225. Additionally, or alternatively, the UE 115-a may be triggered to transmit a report 225 if the buffer 205 is at capacity (e.g., full) or satisfies a threshold capacity (e.g., a capacity at or above a threshold value, a quantity of entries 210 at or above a threshold value), as misalignments with the estimate of the network entity 105-a may be more likely when the buffer 205 is near capacity. In some examples, the UE 115-a may transmit an aperiodic report 225 via MAC-CE, as the network entity 105-a may not be aware that the UE 115-a is to transmit a report 225. In some other examples, the UE 115-a may transmit an aperiodic report 225 by indicating, in a first UCI transmission (e.g., using one or more bits multiplexed with a UCI transmission), that a report 225 is to be transmitted in a second, upcoming UCI transmission.

In some examples, the report 225 may include one or more bitmaps that indicate whether a transport block has a corresponding entry 210 in the buffer 205. Each respective bit in a bitmap may indicate whether a respective transport block corresponding to a HARQ process ID has a corresponding entry 210 in the buffer 205. For example, a value of one may indicate that the transport block has a corresponding entry 210, while a value of zero may indicate that the transport block does not have a corresponding entry 210 in the buffer 205. In some cases, the report 225 may include one bitmap (e.g., a long bitmap) for each component carrier associated with the UE 115-a. In some examples, the UE 115-a may be configured (e.g., by the network entity 105-a) with a subset of component carriers (e.g., of an overall set of component carriers), a subset of HARQ process IDs (e.g., of an overall set of component carriers), or both, for which bitmaps may be included in the report 225. In some examples, the report 225 may also indicate (e.g., via one bit of a bitmap) whether a transport block is associated with an NDI (e.g., by including a second bitmap, or a second bit per transport block in the first bitmap).

In some other examples, the report 225 may be or include a list of entries 210 that are included in the buffer 205 (e.g., an entry 210-a, an entry 210-b, an entry 210-c, and an entry 210-d). The list may include information to identify each transport block associated with each entry 210 in the buffer 205. For example, the list may include an indication of carrier ID, HARQ ID, NDI, or a combination thereof, that may be used by the network entity 105-a to identify a transport block. As such, the UE 115-a may indicate the transport blocks that have associated entries 210 and may exclude any transport blocks that do not have associated entries 210, which may reduce a size of the report. However, this may result in a variable size for the report 225.

In some examples, the variable-size report 225 may be transmitted using a two-part message, such as two-part UCI. Alternatively, the size of the report 225 may be fixed. For instance, the size of the report 225 may be configured to be proportional to (e.g., equal to, a multiple of) the capacity of the buffer 205 (e.g., a quantity of entries or pages supported by the buffer 205). If the buffer 205 is not at full capacity, the report 225 may include one or more special values reserved for unused entries (e.g., the report 225 may be zero padded using zero bits). Alternatively, the UE 115-a may be configured (e.g., by the network entity 105-a, via an RRC message) with a quantity of entries to be indicated in the report 225. If the buffer 205 contains more entries than the configured quantity, the UE 115-a may transmit a second report 225. In some cases, the report 225 may include a flag bit to indicate whether the report 225 is a continuation of a previous report 225 (e.g., in the case of the UE 115-a transmitting two reports 225). The report 225 may similarly be filled with reserved values (e.g., zero bits) if the buffer 205 contains less entries 210 than the configured quantity.

In some examples, the UE 115-a may report ACK/NACK feedback for a code block group. For example, each transport block may include a plurality of code blocks, which may be grouped into one or more code block groups. The UE 115-a may report a NACK corresponding to a code block group if decoding of a code block within the code block group was unsuccessful. In these examples, the bitmaps or the list included in a report 225 may also indicate code block groups or individual code blocks (e.g., instead of transport blocks). That is, each bit of a bitmap may indicate whether an entry 210 corresponding to a code block group or a code block is in the buffer 205. Similarly, if the report 225 includes an indication of a list of entries 210, the list may indicate code block groups or individual code blocks that are associated with an entry 210 stored in the buffer 205.

In some additional examples, the report 225 may indicate a time instance associated with a purging operation (e.g., a latest purging operation). For example, the time instance may indicate to the network entity 105-a that entries 210 corresponding to transport blocks (e.g., or code blocks, or code block groups) transmitted prior to the time instance have been purged from the buffer 205, while entries 210 corresponding to transport blocks transmitted after the time instance are still in the buffer 205. Alternatively, the time instance may indicate to the network entity 105-a that entries 210 corresponding to a NACK transmitted prior to the time instance have been purged from the buffer 205, while entries 210 corresponding to a NACK transmitted after the time instance are still in the buffer 205. In some examples, the time instance may be indicated as an index included in the report 225, which may correspond to a time instance in a configured table. In some cases, the time instance may be a time offset, for example, with respect to a time associated with transmission of the report 225, and the index included in the report 225 may indicate a time offset from a time offset table.

Accordingly, the UE 115-a may transmit a report 225 to indicate buffer usage information to the network entity 105-a, and the network entity 105-a may update the estimate of the buffer usage information maintained by the network entity 105-a. As such, the reliability of retransmissions between the UE 115-a and the network entity 105-a may be improved.

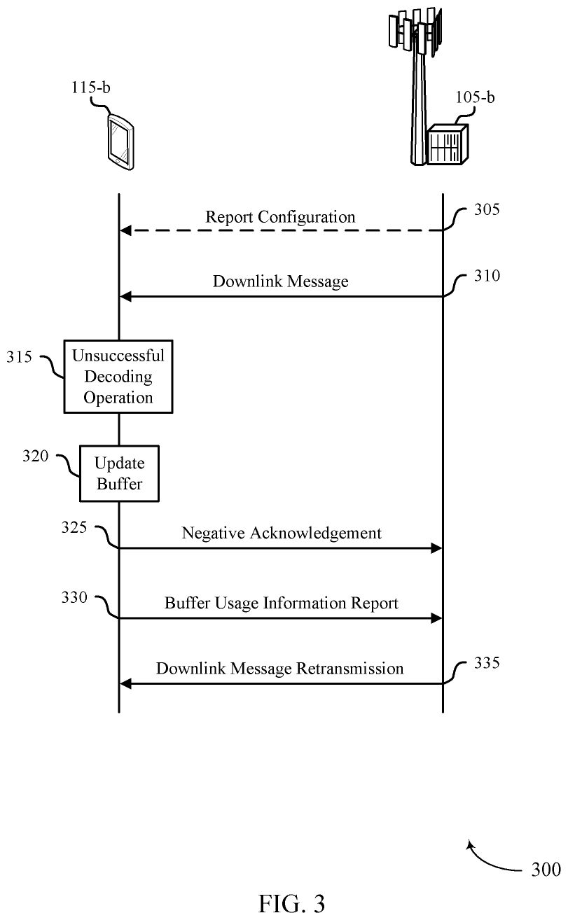

FIG. 3 shows an example of a process flow 300 that supports soft buffer status reporting in accordance with one or more aspects of the present disclosure. The process flow 300 illustrates communications between a UE 115-b and a network entity 105-b, which may be examples of corresponding devices as described herein, with reference to FIGS. 1 and 2. In some examples, steps illustrated in the process flow 300 may be performed in different orders. Additionally, some steps may be added to the process flow 300, and some steps shown may be omitted.

At 305, the network entity 105-b may transmit a report configuration to the UE 115-b. In some examples, the report configuration may indicate a periodic set of time resources for transmission of buffer usage information reports by the UE 115-b. For example, the report configuration may indicate a period (e.g., a periodicity), an offset (e.g., a time offset), or both, which may indicate a periodic set of time resources to the UE 115-b. In some other examples, the report configuration may trigger the UE 115-b to transmit a buffer usage information report (e.g., in a next UCI transmission). Additionally, or alternatively, the report configuration may indicate one or more conditions that may trigger the UE 115-b to transmit a buffer usage information report.

At 310, the network entity 105-b may transmit a downlink message. For example, the network entity 105-b may transmit the downlink message to the UE 115-b via a transport block. In some examples, the downlink message may be associated with a feedback occasion for transmission of a feedback message (e.g., HARQ feedback), such as an ACK message or a NACK message.

At 315, the UE 115-b may perform a decoding operation for the downlink message. The decoding operation may be at least partially unsuccessful, and the UE 115-b may be unable to decode the downlink message. At 320, the UE 115-b may update a buffer of the UE 115-b based on the decoding operation being unsuccessful. For example, the UE 115-b may store decoding information associated with the decoding operation (e.g., one or more LLRs) in the buffer, which may be used for soft combining during a decoding operation for a retransmission of the downlink message.

At 325, the UE 115-b may transmit a NACK during a feedback occasion associated with the downlink message based on the decoding operation for the downlink message being at least partially unsuccessful. The network entity 105-b may update an estimate of the information contained in the buffer of the UE 115-b based on the NACK. For example, the network entity 105-b may estimate that decoding information associated with the downlink message was stored in the buffer of the UE 115-b.

At 330, the UE 115-b may transmit the buffer usage information report to the network entity 105-b. In some examples, the buffer usage information report may indicate transport blocks for which entries are stored in the buffer, for example, by transmitting one or more bitmaps. For example, the one or more bitmaps may indicate whether each transport block is associated with an entry stored in the buffer, whether each transport block is associated with an NDI, or both. In some other examples, the buffer usage information report may include a list of one or more entries stored in the buffer, and the list may include one or more carrier IDs, HARQ IDs, NDIs, or a combination thereof, to indicate one or more transport block associated with each respective entry. In some other examples, the UE 115 may report an indication of a time instance associated with a latest purging operation, which may indicate that transport blocks transmitted prior to the time instance are not associated with an entry in the buffer, while transport blocks transmitted after the time instance are associated with an entry in the buffer. In some examples, the latest purging operation may be transmitted via UCI (e.g., a single UCI or a two-part UCI) and may be multiplexed with another UCI transmission. Alternatively, the latest purging operation may be transmitted via MAC-CE or another message.

At 335, the network entity 105-b may transmit a retransmission of the downlink message based on the buffer usage information report. For example, the buffer usage information report may indicate that decoding information associated with the downlink message is not included in the buffer. As such, the network entity 105-b may perform a retransmission for the downlink message using an RVID with a value of zero, which may indicate a systematic base for decoding by the UE 115-b (e.g., a base for LDPC code). Additionally, or alternatively, the network entity 105-b may form a new transport block for the retransmission using different formatting, which may include a different quantity of bits as the original transport block, different information, or different parameters. Alternatively, if the buffer usage information report indicates that the buffer does contain decoding information associated with the downlink message, the network entity 105-b may transmit the retransmission using the same transport block, and the network entity 105-b may apply different puncturing patterns, for example.

Accordingly, by transmitting the buffer usage information report, the UE 115-b may allow the network entity 105-b to update the estimate of the buffer usage information maintained by the network entity 105-b. As such, the reliability of retransmissions between the UE 115-b and the network entity 105-b may be improved.

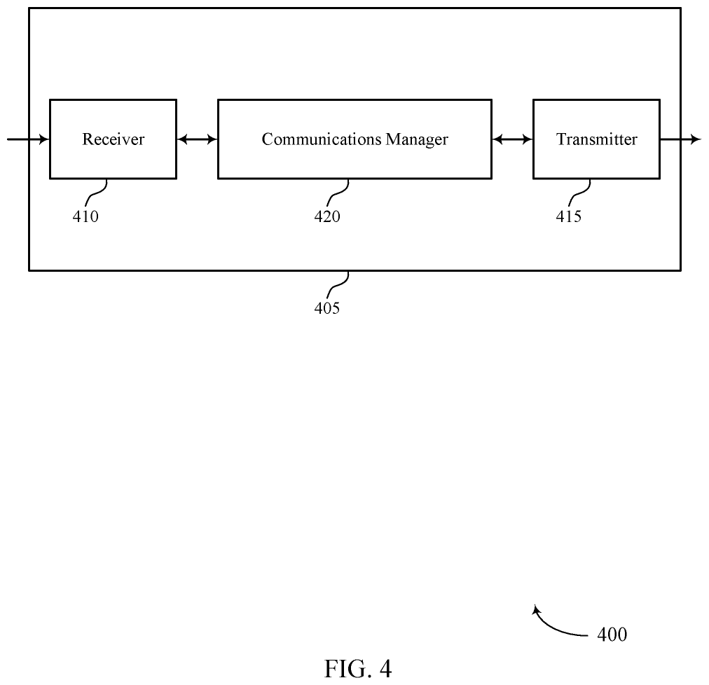

FIG. 4 shows a block diagram 400 of a device 405 that supports soft buffer status reporting in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to soft buffer status reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to soft buffer status reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of soft buffer status reporting as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for performing a decoding operation on a downlink message for the UE. The communications manager 420 is capable of, configured to, or operable to support a means for storing, in a buffer of the UE, decoding information associated with the decoding operation on the downlink message based on the decoding operation on the downlink message being at least partially unsuccessful. The communications manager 420 is capable of, configured to, or operable to support a means for transmitting, to the network entity, a report indicating buffer usage information of the buffer of the UE, where the buffer usage information indicates one or more parameters associated with the decoding information stored in the buffer of the UE.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for soft buffer status reporting as to increase communication reliability and reduce processing associated with retransmissions.

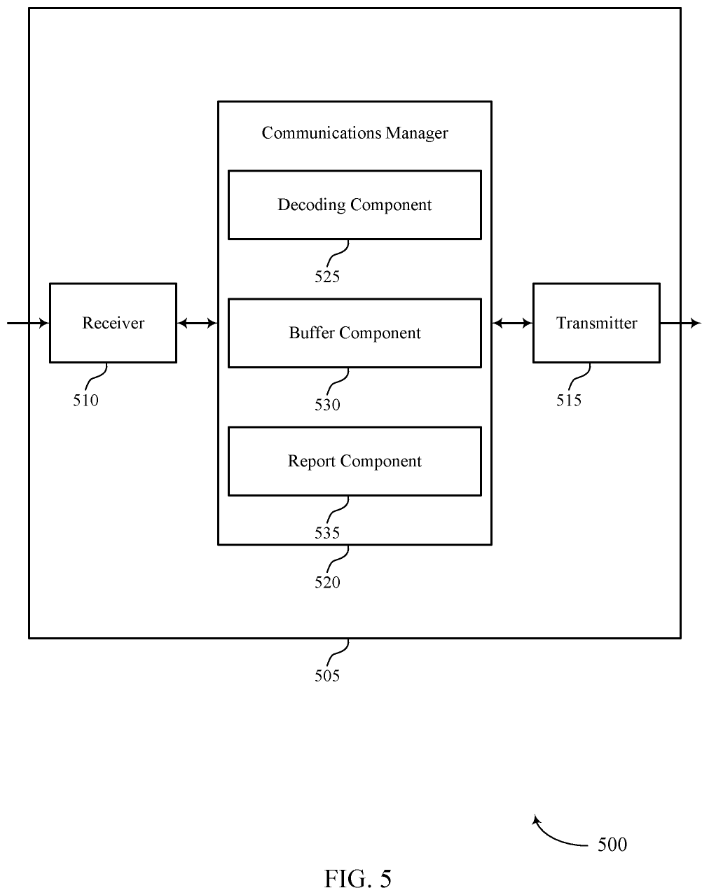

FIG. 5 shows a block diagram 500 of a device 505 that supports soft buffer status reporting in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to soft buffer status reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to soft buffer status reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of soft buffer status reporting as described herein. For example, the communications manager 520 may include a decoding component 525, a buffer component 530, a report component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The decoding component 525 is capable of, configured to, or operable to support a means for performing a decoding operation on a downlink message for the UE. The buffer component 530 is capable of, configured to, or operable to support a means for storing, in a buffer of the UE, decoding information associated with the decoding operation on the downlink message based on the decoding operation on the downlink message being at least partially unsuccessful. The report component 535 is capable of, configured to, or operable to support a means for transmitting, to the network entity, a report indicating buffer usage information of the buffer of the UE, where the buffer usage information indicates one or more parameters associated with the decoding information stored in the buffer of the UE.

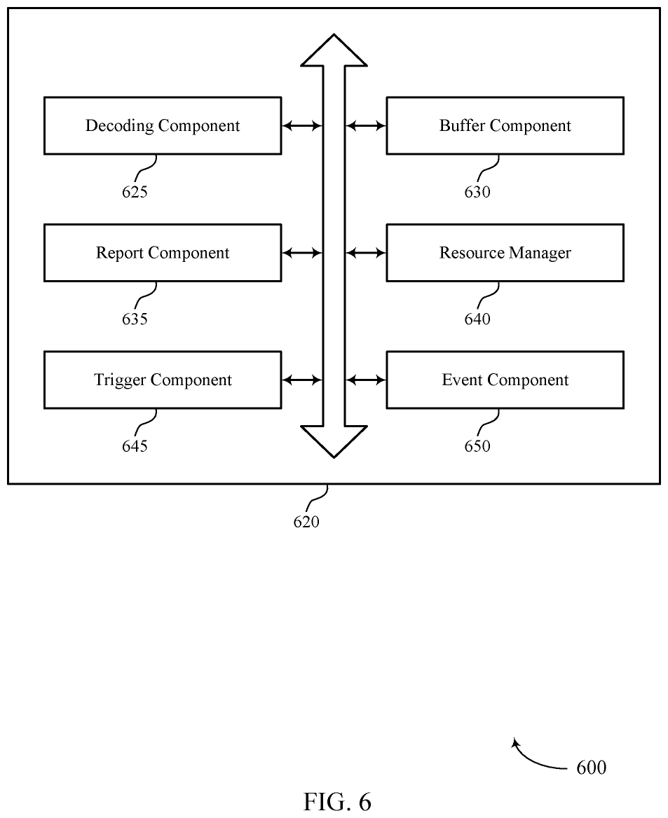

FIG. 6 shows a block diagram 600 of a communications manager 620 that supports soft buffer status reporting in accordance with one or more aspects of the present disclosure. The communications manager 620 may be an example of aspects of a communications manager 420, a communications manager 520, or both, as described herein. The communications manager 620, or various components thereof, may be an example of means for performing various aspects of soft buffer status reporting as described herein. For example, the communications manager 620 may include a decoding component 625, a buffer component 630, a report component 635, a resource manager 640, a trigger component 645, an event component 650, or any combination thereof. Each of these components, or components or subcomponents thereof (e.g., one or more processors, one or more memories), may communicate, directly or indirectly, with one another (e.g., via one or more buses).

The decoding component 625 is capable of, configured to, or operable to support a means for performing a decoding operation on a downlink message for the UE. The buffer component 630 is capable of, configured to, or operable to support a means for storing, in a buffer of the UE, decoding information associated with the decoding operation on the downlink message based on the decoding operation on the downlink message being at least partially unsuccessful. The report component 635 is capable of, configured to, or operable to support a means for transmitting, to the network entity, a report indicating buffer usage information of the buffer of the UE, where the buffer usage information indicates one or more parameters associated with the decoding information stored in the buffer of the UE.

In some examples, the decoding component 625 is capable of, configured to, or operable to support a means for receiving a retransmission of the downlink message based on the report. In some examples, the decoding information includes one or more LLRs for a transport block associated with the downlink message, and the decoding component 625 is capable of, configured to, or operable to support a means for performing a second decoding operation on the retransmission based on the one or more LLRs.

In some examples, the resource manager 640 is capable of, configured to, or operable to support a means for receiving, from the network entity, a message indicating a periodic set of time resources for transmission of the report in accordance with a periodicity.

In some examples, to support transmitting the report, the resource manager 640 is capable of, configured to, or operable to support a means for transmitting the report via one or more time resources of the periodic set of time resources in accordance with the periodicity.

In some examples, the resource manager 640 is capable of, configured to, or operable to support a means for refraining from transmitting a second report via one or more time resources of the periodic set of time resources based on the buffer usage information being the same as buffer usage information included in a previous report, a utilization of the buffer being below a threshold value, the buffer being empty, or a combination thereof.

In some examples, the trigger component 645 is capable of, configured to, or operable to support a means for receiving, from the network entity, a message including one or more downlink control information bits, where the one or more downlink control information bits trigger the UE to transmit the report. In some examples, the one or more downlink control information bits indicate one or more priority values, one or more component carriers, or a combination thereof, associated with buffer usage information to be included in the report.

In some examples, the event component 650 is capable of, configured to, or operable to support a means for detecting an event at the UE, where the report is transmitted based on detection of the event by the UE. In some examples, to support detecting the event, the event component 650 is capable of, configured to, or operable to support a means for detecting an absence of a downlink control information transmission from the network entity.

In some examples, to support transmitting the report, the event component 650 is capable of, configured to, or operable to support a means for transmitting the report based on a buffer usage satisfying a threshold value, where the event includes the buffer usage satisfying the threshold value. In some examples, the one or more parameters indicate a transport block associated with the decoding information stored in the buffer. In some examples, the one or more parameters include an indication of a carrier identification value, a hybrid automatic repeat request identification value, a new data indication associated with the downlink message, or a combination thereof.

In some examples, the buffer component 630 is capable of, configured to, or operable to support a means for storing, in the buffer of the UE, additional decoding information associated with a set of multiple decoding operations for a respective set of multiple downlink messages, each of the set of multiple decoding operations being at least partially unsuccessful.

In some examples, the report component 635 is capable of, configured to, or operable to support a means for transmitting the report indicating the buffer usage information, where the buffer usage information indicates one or more parameters of the decoding information associated with the set of multiple decoding operations.

In some examples, the buffer usage information includes a respective bitmap for each component carrier of a set of component carriers associated with the set of multiple downlink messages, each respective bit of a first bitmap for a first component carrier of the set of component carriers indicating whether decoding information associated with a respective transport block for a respective downlink message of the set of multiple downlink messages is stored in the buffer.

In some examples, the buffer usage information indicates a time instance, the time instance indicating that decoding information associated with downlink messages transmitted after the time instance is stored in the buffer and decoding information associated with at least one downlink message transmitted before the time instance is purged from the buffer. In some examples, the report is transmitted via an uplink control information message.

In some examples, the report component 635 is capable of, configured to, or operable to support a means for transmitting a first uplink control information message indicating a size of the report. In some examples, the report component 635 is capable of, configured to, or operable to support a means for transmitting a second uplink control information message including the report. In some examples, the report is transmitted via a medium access control-control element message.

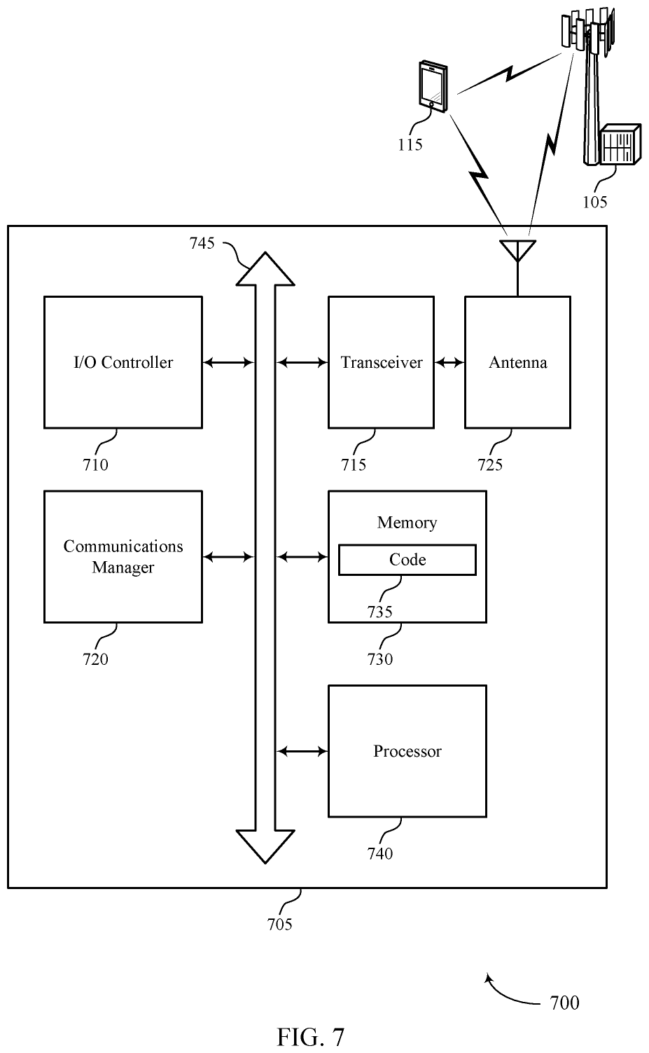

FIG. 7 shows a diagram of a system 700 including a device 705 that supports soft buffer status reporting in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROIDR, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable (e.g., processor-executable) code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting soft buffer status reporting). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

For example, the communications manager 720 is capable of, configured to, or operable to support a means for performing a decoding operation on a downlink message for the UE. The communications manager 720 is capable of, configured to, or operable to support a means for storing, in a buffer of the UE, decoding information associated with the decoding operation on the downlink message based on the decoding operation on the downlink message being at least partially unsuccessful. The communications manager 720 is capable of, configured to, or operable to support a means for transmitting, to the network entity, a report indicating buffer usage information of the buffer of the UE, where the buffer usage information indicates one or more parameters associated with the decoding information stored in the buffer of the UE.

By including or configuring the communications manager 720 in accordance with examples as described herein, the device 705 may support techniques for soft buffer status reporting as to increase communication reliability, improve coordination between devices, and reduce processing associated with retransmissions.

In some examples, the communications manager 720 may be configured to perform various operations (e.g., receiving, monitoring, transmitting) using or otherwise in cooperation with the transceiver 715, the one or more antennas 725, or any combination thereof. For example, the communications manager 720 may be configured to receive or transmit messages or other signaling as described herein via the transceiver 715. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of soft buffer status reporting as described herein, or the at least one processor 740 and the at least one memory 730 may be otherwise configured to, individually or collectively, perform or support such operations.

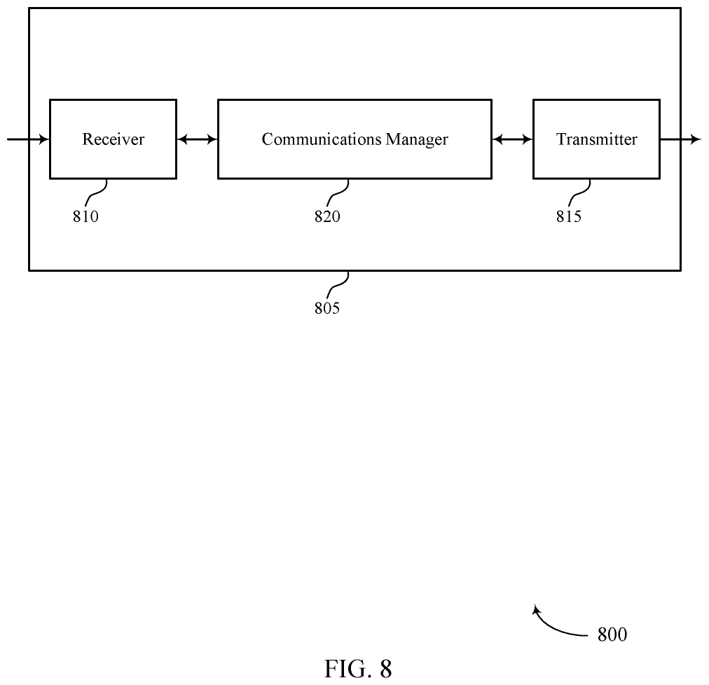

FIG. 8 shows a block diagram 800 of a device 805 that supports soft buffer status reporting in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of soft buffer status reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for transmitting a downlink message to a UE. The communications manager 820 is capable of, configured to, or operable to support a means for receiving, from the UE, a report indicating buffer usage information of a buffer of the UE, where the buffer usage information indicates one or more parameters of decoding information associated with at least a partially unsuccessful decoding operation of the downlink message at the UE. The communications manager 820 is capable of, configured to, or operable to support a means for transmitting a retransmission of the downlink message based on receiving the report.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for soft buffer status reporting as to increase communication reliability and reduce processing associated with retransmissions.

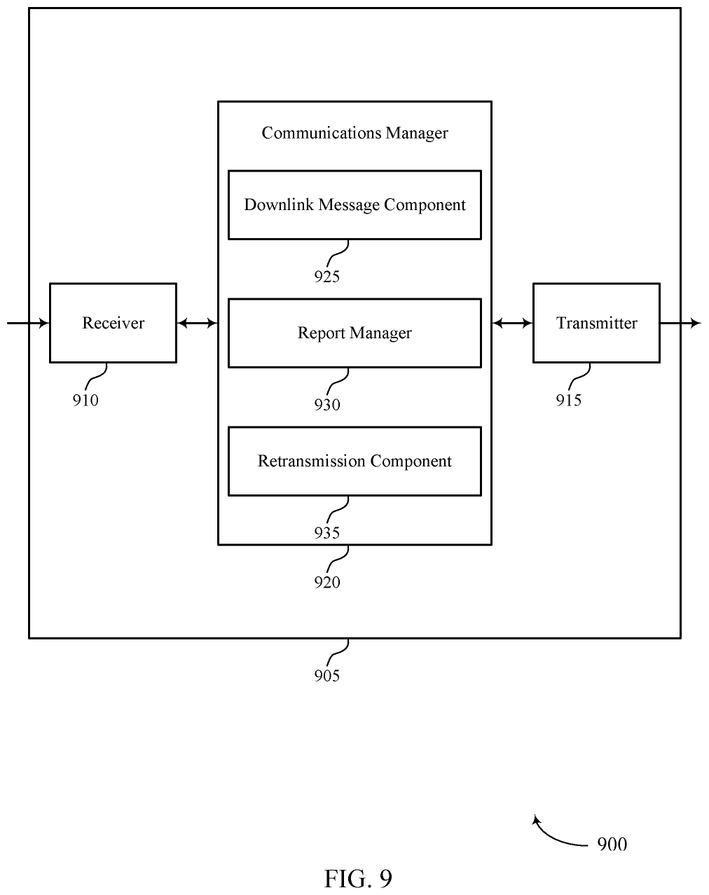

FIG. 9 shows a block diagram 900 of a device 905 that supports soft buffer status reporting in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of soft buffer status reporting as described herein. For example, the communications manager 920 may include a downlink message component 925, a report manager 930, a retransmission component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The downlink message component 925 is capable of, configured to, or operable to support a means for transmitting a downlink message to a UE. The report manager 930 is capable of, configured to, or operable to support a means for receiving, from the UE, a report indicating buffer usage information of a buffer of the UE, where the buffer usage information indicates one or more parameters of decoding information associated with at least a partially unsuccessful decoding operation of the downlink message at the UE. The retransmission component 935 is capable of, configured to, or operable to support a means for transmitting a retransmission of the downlink message based on receiving the report.

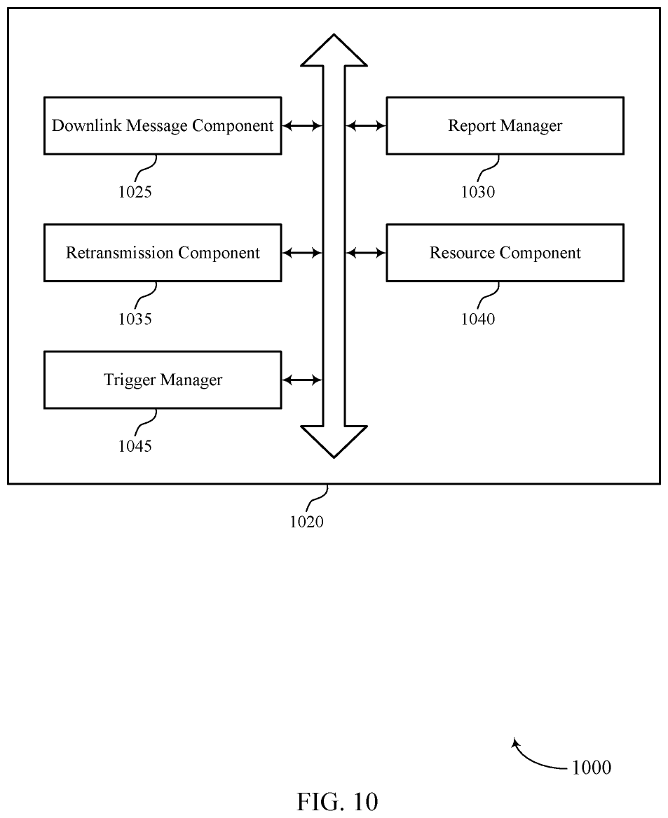

FIG. 10 shows a block diagram 1000 of a communications manager 1020 that supports soft buffer status reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of soft buffer status reporting as described herein. For example, the communications manager 1020 may include a downlink message component 1025, a report manager 1030, a retransmission component 1035, a resource component 1040, a trigger manager 1045, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The downlink message component 1025 is capable of, configured to, or operable to support a means for transmitting a downlink message to a UE. The report manager 1030 is capable of, configured to, or operable to support a means for receiving, from the UE, a report indicating buffer usage information of a buffer of the UE, where the buffer usage information indicates one or more parameters of decoding information associated with at least a partially unsuccessful decoding operation of the downlink message at the UE. The retransmission component 1035 is capable of, configured to, or operable to support a means for transmitting a retransmission of the downlink message based on receiving the report. In some examples, the decoding information includes one or more log-likelihood ratios for a transport block associated with the downlink message.

In some examples, the resource component 1040 is capable of, configured to, or operable to support a means for transmitting a message indicating a periodic set of time resources for transmission of the report by the UE in accordance with a periodicity, where the report is received via a one or more resources of the periodic set of time resources in accordance with the periodicity.

In some examples, the trigger manager 1045 is capable of, configured to, or operable to support a means for transmitting a message including one or more downlink control information bits, where the one or more downlink control information bits trigger the UE to transmit the report.

In some examples, the one or more downlink control information bits indicate one or more priority values, one or more component carriers, or a combination thereof, associated with buffer usage information to be included in the report. In some examples, the one or more parameters indicate a transport block associated with the decoding information stored in the buffer. In some examples, the one or more parameters include an indication of a carrier identification value, a hybrid automatic repeat request identification value, a new data indication associated with the downlink message, or a combination thereof.

In some examples, to support receiving the report, the report manager 1030 is capable of, configured to, or operable to support a means for receiving the report indicating the buffer usage information, where the buffer usage information indicates one or more parameters of additional decoding information associated with a set of multiple decoding operations corresponding to a set of multiple downlink messages, each of the set of multiple decoding operations being at least partially unsuccessful.

In some examples, the buffer usage information includes a respective bitmap for each component carrier of a set of component carriers associated with the set of multiple downlink messages, each respective bit of a first bitmap for a first component carrier of the set of component carriers indicating whether decoding information associated with a respective transport block for a respective downlink message of the set of multiple downlink messages is stored in the buffer.

In some examples, the buffer usage information indicates a time instance, the time instance indicating that decoding information associated with downlink messages transmitted after the time instance is stored in the buffer and decoding information associated with at least one downlink message transmitted before the time instance is purged from the buffer. In some examples, the report is received via an uplink control information message.

In some examples, the report manager 1030 is capable of, configured to, or operable to support a means for receiving a first uplink control information message indicating a size of the report. In some examples, the report manager 1030 is capable of, configured to, or operable to support a means for receiving a second uplink control information message including the report. In some examples, the report is transmitted via a medium access control-control element message.

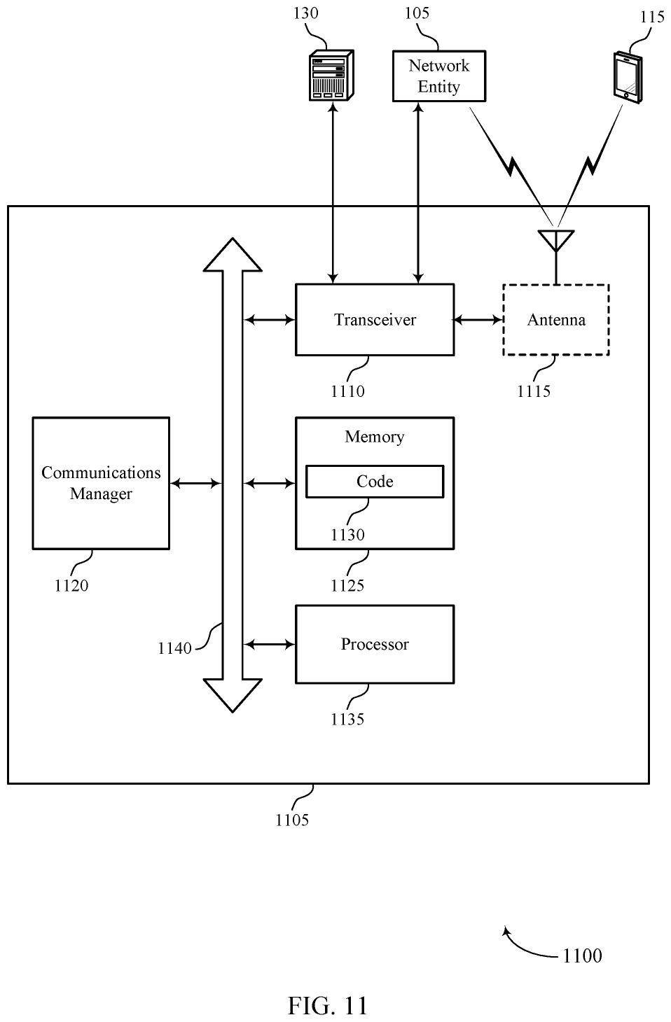

FIG. 11 shows a diagram of a system 1100 including a device 1105 that supports soft buffer status reporting in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable (e.g., processor-executable) code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting soft buffer status reporting). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105 and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

For example, the communications manager 1120 is capable of, configured to, or operable to support a means for transmitting a downlink message to a UE. The communications manager 1120 is capable of, configured to, or operable to support a means for receiving, from the UE, a report indicating buffer usage information of a buffer of the UE, where the buffer usage information indicates one or more parameters of decoding information associated with at least a partially unsuccessful decoding operation of the downlink message at the UE. The communications manager 1120 is capable of, configured to, or operable to support a means for transmitting a retransmission of the downlink message based on receiving the report.

By including or configuring the communications manager 1120 in accordance with examples as described herein, the device 1105 may support techniques for soft buffer status reporting as to increase communication reliability, improve coordination between devices, and reduce processing associated with retransmissions.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of soft buffer status reporting as described herein, or the at least one processor 1135 and the at least one memory 1125 may be otherwise configured to, individually or collectively, perform or support such operations.

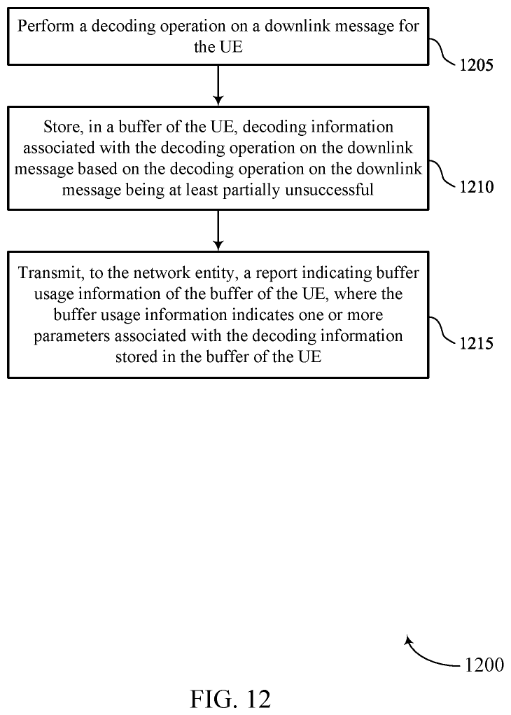

FIG. 12 shows a flowchart illustrating a method 1200 that supports soft buffer status reporting in accordance with examples as described herein. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include performing a decoding operation on a downlink message for the UE. The operations of block 1205 may be performed in accordance with examples as disclosed herein. In some examples, aspects of the operations of 1205 may be performed by a decoding component 625 as described with reference to FIG. 6.

At 1210, the method may include storing, in a buffer of the UE, decoding information associated with the decoding operation on the downlink message based on the decoding operation on the downlink message being at least partially unsuccessful. The operations of block 1210 may be performed in accordance with examples as disclosed herein. In some examples, aspects of the operations of 1210 may be performed by a buffer component 630 as described with reference to FIG. 6.

At 1215, the method may include transmitting, to the network entity, a report indicating buffer usage information of the buffer of the UE, where the buffer usage information indicates one or more parameters associated with the decoding information stored in the buffer of the UE. The operations of block 1215 may be performed in accordance with examples as disclosed herein. In some examples, aspects of the operations of 1215 may be performed by a report component 635 as described with reference to FIG. 6.

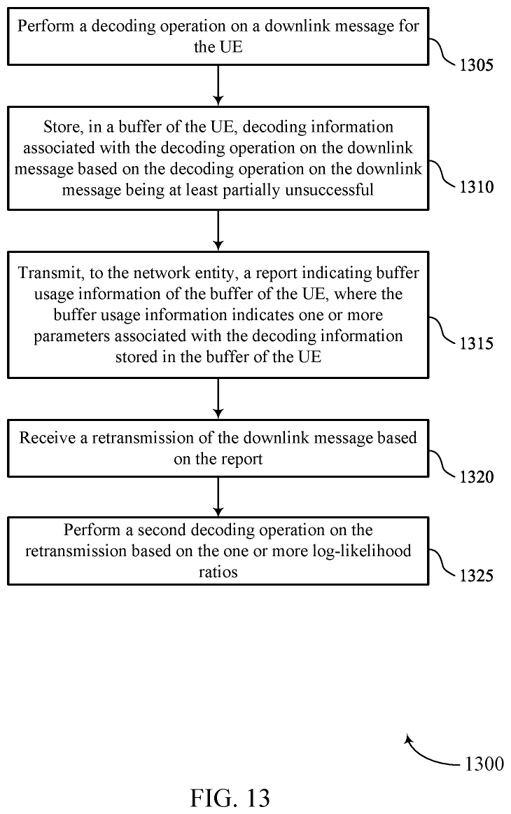

FIG. 13 shows a flowchart illustrating a method 1300 that supports soft buffer status reporting in accordance with examples as described herein. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware, such as, but not limited to, a communications manager 720, an I/O controller 710, a transceiver 715, an antenna 725, at least one memory 730, code 735, and at least one processor 740, as described herein.

At 1305, the method may include performing a decoding operation on a downlink message for the UE. The operations of block 1305 may be performed in accordance with examples as disclosed herein. In some examples, aspects of the operations of 1305 may be performed by a decoding component 625 as described with reference to FIG. 6.

At 1310, the method may include storing, in a buffer of the UE, decoding information associated with the decoding operation on the downlink message based on the decoding operation on the downlink message being at least partially unsuccessful. The operations of block 1310 may be performed in accordance with examples as disclosed herein. In some examples, aspects of the operations of 1310 may be performed by a buffer component 630 as described with reference to FIG. 6.

At 1315, the method may include transmitting, to the network entity, a report indicating buffer usage information of the buffer of the UE, where the buffer usage information indicates one or more parameters associated with the decoding information stored in the buffer of the UE. The operations of block 1315 may be performed in accordance with examples as disclosed herein. In some examples, aspects of the operations of 1315 may be performed by a report component 635 as described with reference to FIG. 6.

At 1320, the method may include receiving a retransmission of the downlink message based on the report. The operations of block 1320 may be performed in accordance with examples as disclosed herein. In some examples, aspects of the operations of 1320 may be performed by a decoding component 625 as described with reference to FIG. 6.

At 1325, the method may include performing a second decoding operation on the retransmission based on the one or more log-likelihood ratios. The operations of block 1325 may be performed in accordance with examples as disclosed herein. In some examples, aspects of the operations of 1325 may be performed by a decoding component 625 as described with reference to FIG. 6.

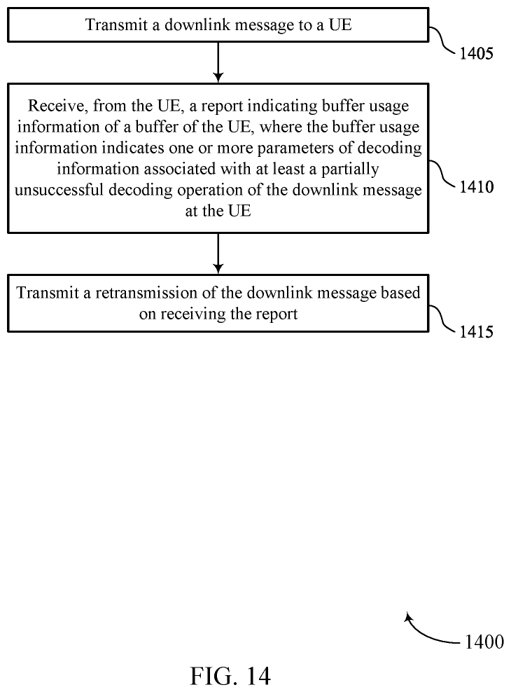

FIG. 14 shows a flowchart illustrating a method 1400 that supports soft buffer status reporting in accordance with examples as described herein. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware, such as a receiver 810, a transmitter 815, and a communications manager 820, as described herein.

At 1405, the method may include transmitting a downlink message to a UE. The operations of block 1405 may be performed in accordance with examples as disclosed herein. In some examples, aspects of the operations of 1405 may be performed by a downlink message component 1025 as described with reference to FIG. 10.

At 1410, the method may include receiving, from the UE, a report indicating buffer usage information of a buffer of the UE, where the buffer usage information indicates one or more parameters of decoding information associated with at least a partially unsuccessful decoding operation of the downlink message at the UE. The operations of block 1410 may be performed in accordance with examples as disclosed herein. In some examples, aspects of the operations of 1410 may be performed by a report manager 1030 as described with reference to FIG. 10.

At 1415, the method may include transmitting a retransmission of the downlink message based on receiving the report. The operations of block 1415 may be performed in accordance with examples as disclosed herein. In some examples, aspects of the operations of 1415 may be performed by a retransmission component 1035 as described with reference to FIG. 10.

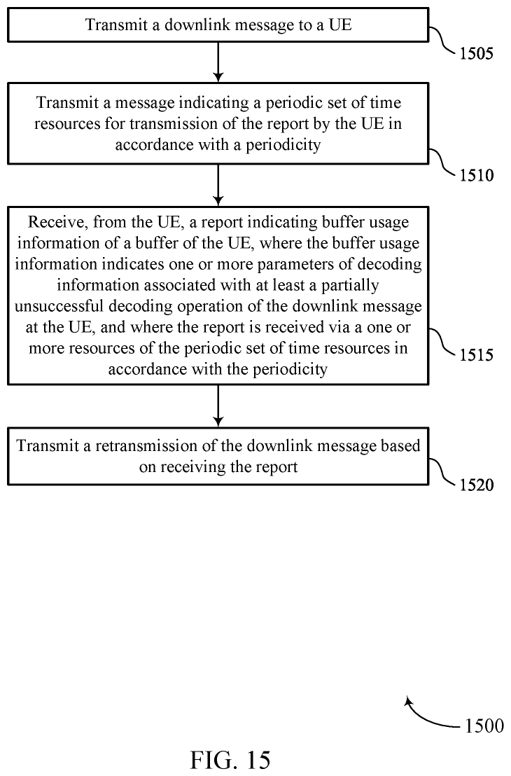

FIG. 15 shows a flowchart illustrating a method 1500 that supports soft buffer status reporting in accordance with examples as described herein. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a downlink message to a UE.

The operations of block 1505 may be performed in accordance with examples as disclosed herein. In some examples, aspects of the operations of 1505 may be performed by a downlink message component 1025 as described with reference to FIG. 10.

At 1510, the method may include transmitting a message indicating a periodic set of time resources for transmission of the report by the UE in accordance with a periodicity. The operations of block 1510 may be performed in accordance with examples as disclosed herein. In some examples, aspects of the operations of 1510 may be performed by a resource component 1040 as described with reference to FIG. 10.

At 1515, the method may include receiving, from the UE, a report indicating buffer usage information of a buffer of the UE, where the buffer usage information indicates one or more parameters of decoding information associated with at least a partially unsuccessful decoding operation of the downlink message at the UE, and where the report is received via a one or more resources of the periodic set of time resources in accordance with the periodicity. The operations of block 1515 may be performed in accordance with examples as disclosed herein. In some examples, aspects of the operations of 1515 may be performed by a report manager 1030 as described with reference to FIG. 10.

At 1520, the method may include transmitting a retransmission of the downlink message based on receiving the report. The operations of block 1520 may be performed in accordance with examples as disclosed herein. In some examples, aspects of the operations of 1520 may be performed by a retransmission component 1035 as described with reference to FIG. 10.

The following provides an overview of aspects of the present disclosure:
Aspect 1: A method for wireless communications by a UE, comprising: performing a decoding operation on a downlink message for the UE; storing, in a buffer of the UE, decoding information associated with the decoding operation on the downlink message based at least in part on the decoding operation on the downlink message being at least partially unsuccessful; and transmitting, to the network entity, a report indicating buffer usage information of the buffer of the UE, wherein the buffer usage information indicates one or more parameters associated with the decoding information stored in the buffer of the UE.
Aspect 2: The method of aspect 1, wherein the decoding information comprises one or more log-likelihood ratios for a transport block associated with the downlink message, the method further comprising: receiving a retransmission of the downlink message based at least in part on the report; and performing a second decoding operation on the retransmission based at least in part on the one or more log-likelihood ratios.
Aspect 3: The method of any of aspects 1 through 2, further comprising: receiving, from the network entity, a message indicating a periodic set of time resources for transmission of the report in accordance with a periodicity.
Aspect 4: The method of aspect 3, wherein transmitting the report comprises: transmitting the report via one or more time resources of the periodic set of time resources in accordance with the periodicity.
Aspect 5: The method of any of aspects 3 through 4, further comprising: refraining from transmitting a second report via one or more time resources of the periodic set of time resources based at least in part on the buffer usage information being the same as buffer usage information included in a previous report, a utilization of the buffer being below a threshold value, the buffer being empty, or a combination thereof.
Aspect 6: The method of any of aspects 1 through 2, further comprising: receiving, from the network entity, a message comprising one or more downlink control information bits, wherein the one or more downlink control information bits trigger the UE to transmit the report.
Aspect 7: The method of aspect 6, wherein the one or more downlink control information bits indicate one or more priority values, one or more component carriers, or a combination thereof, associated with buffer usage information to be included in the report.
Aspect 8: The method of any of aspects 1 through 2, further comprising: detecting an event at the UE, wherein the report is transmitted based at least in part on detection of the event by the UE.
Aspect 9: The method of aspect 8, wherein detecting the event comprises: detecting an absence of a downlink control information transmission from the network entity.
Aspect 10: The method of any of aspects 8 through 9, wherein transmitting the report comprises: transmitting the report based at least in part on a buffer usage satisfying a threshold value, wherein the event comprises the buffer usage satisfying the threshold value.
Aspect 11: The method of any of aspects 1 through 10, wherein the one or more parameters indicate a transport block associated with the decoding information stored in the buffer.
Aspect 12: The method of aspect 11, wherein the one or more parameters comprise an indication of a carrier identification value, a hybrid automatic repeat request identification value, a new data indication associated with the downlink message, or a combination thereof.
Aspect 13: The method of any of aspects 1 through 12, further comprising: storing, in the buffer of the UE, additional decoding information associated with a plurality of decoding operations for a respective plurality of downlink messages, each of the plurality of decoding operations being at least partially unsuccessful,
Aspect 14: The method of aspect 13, further comprising: transmitting the report indicating the buffer usage information, wherein the buffer usage information indicates one or more parameters of the decoding information associated with the plurality of decoding operations.
Aspect 15: The method of any of aspects 13 through 14, wherein the buffer usage information comprises a respective bitmap for each component carrier of a set of component carriers associated with the plurality of downlink messages, each respective bit of a first bitmap for a first component carrier of the set of component carriers indicating whether decoding information associated with a respective transport block for a respective downlink message of the plurality of downlink messages is stored in the buffer.
Aspect 16: The method of any of aspects 1 through 12, wherein the buffer usage information indicates a time instance, the time instance indicating that decoding information associated with downlink messages transmitted after the time instance is stored in the buffer and decoding information associated with at least one downlink message transmitted before the time instance is purged from the buffer.
Aspect 17: The method of any of aspects 1 through 16, wherein the report is transmitted via an uplink control information message.
Aspect 18: The method of aspect 17, further comprising: transmitting a first uplink control information message indicating a size of the report; and transmitting a second uplink control information message including the report.
Aspect 19: The method of any of aspects 1 through 16, wherein the report is transmitted via a medium access control-control element message.
Aspect 20: A method for wireless communication by a network entity, comprising: transmitting a downlink message to a UE; receiving, from the UE, a report indicating buffer usage information of a buffer of the UE, wherein the buffer usage information indicates one or more parameters of decoding information associated with at least a partially unsuccessful decoding operation of the downlink message at the UE; and transmitting a retransmission of the downlink message based at least in part on receiving the report.
Aspect 21: The method of aspect 20, wherein the decoding information comprises one or more log-likelihood ratios for a transport block associated with the downlink message.
Aspect 22: The method of any of aspects 20 through 21, further comprising: transmitting a message indicating a periodic set of time resources for transmission of the report by the UE in accordance with a periodicity, wherein the report is received via a one or more resources of the periodic set of time resources in accordance with the periodicity.
Aspect 23: The method of any of aspects 20 through 22, further comprising: transmitting a message comprising one or more downlink control information bits, wherein the one or more downlink control information bits trigger the UE to transmit the report.
Aspect 24: The method of aspect 23, wherein the one or more downlink control information bits indicate one or more priority values, one or more component carriers, or a combination thereof, associated with buffer usage information to be included in the report.
Aspect 25: The method of any of aspects 20 through 21, wherein the one or more parameters indicate a transport block associated with the decoding information stored in the buffer.
Aspect 26: The method of aspect 25, wherein the one or more parameters comprise an indication of a carrier identification value, a hybrid automatic repeat request identification value, a new data indication associated with the downlink message, or a combination thereof.
Aspect 27: The method of any of aspects 20 through 26, wherein receiving the report further comprises: receiving the report indicating the buffer usage information, wherein the buffer usage information indicates one or more parameters of additional decoding information associated with a plurality of decoding operations corresponding to a plurality of downlink messages, each of the plurality of decoding operations being at least partially unsuccessful.
Aspect 28: The method of aspect 27, wherein the buffer usage information comprises a respective bitmap for each component carrier of a set of component carriers associated with the plurality of downlink messages, each respective bit of a first bitmap for a first component carrier of the set of component carriers indicating whether decoding information associated with a respective transport block for a respective downlink message of the plurality of downlink messages is stored in the buffer.
Aspect 29: The method of any of aspects 20 through 26, wherein the buffer usage information indicates a time instance, the time instance indicating that decoding information associated with downlink messages transmitted after the time instance is stored in the buffer and decoding information associated with at least one downlink message transmitted before the time instance is purged from the buffer.
Aspect 30: The method of any of aspects 20 through 29, wherein the report is received via an uplink control information message.
Aspect 31: The method of aspect 30, further comprising: receiving a first uplink control information message indicating a size of the report; and receiving a second uplink control information message including the report.
Aspect 32: The method of any of aspects 20 through 29, wherein the report is transmitted via a medium access control-control element message.
Aspect 33: A UE comprising one or more memories storing processor-executable code, a transceiver, and one or more processors of the UE coupled with the one or more memories and the transceiver and individually or collectively operable to execute the code to cause the UE to perform a method of any of aspects 1 through 19.
Aspect 34: A UE comprising at least one means for performing a method of any of aspects 1 through 19.
Aspect 35: A non-transitory computer-readable medium storing code the code comprising instructions executable by a processor to perform a method of any of aspects 1 through 19.
Aspect 36: A network entity comprising one or more memories storing processor-executable code, and one or more processors of the network entity coupled with the one or more memories and individually or collectively operable to execute the code to cause the network entity to perform a method of any of aspects 20 through 32.
Aspect 37: A network entity comprising at least one means for performing a method of any of aspects 20 through 32.
Aspect 38: A non-transitory computer-readable medium storing code the code comprising instructions executable by a processor to perform a method of any of aspects 20 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver and individually or collectively operable to execute the code to cause the UE to:
perform a decoding operation on a downlink message for the UE;
store, in a buffer of the UE, decoding information associated with the decoding operation on the downlink message based at least in part on the decoding operation on the downlink message being at least partially unsuccessful; and
transmit, via the transceiver and to a network entity, a report indicating buffer usage information of the buffer of the UE, wherein the buffer usage information indicates one or more parameters associated with the decoding information stored in the buffer of the UE.

2. The UE of claim 1, wherein the decoding information comprises one or more log-likelihood ratios for a transport block associated with the downlink message, and wherein the one or more processors are individually or collectively operable to execute the code to cause the UE to:
receive, via the transceiver, a retransmission of the downlink message based at least in part on the report; and
perform a second decoding operation on the retransmission based at least in part on the one or more log-likelihood ratios.

3. The UE of claim 1, wherein the one or more processors are individually or collectively further operable to execute the code to cause the UE to:
receive, via the transceiver and from the network entity, a message indicating a periodic set of time resources for transmission of the report in accordance with a periodicity.

4. The UE of claim 3, wherein, to transmit the report, the one or more processors are individually or collectively operable to execute the code to cause the UE to:
transmit, via the transceiver, the report via one or more time resources of the periodic set of time resources in accordance with the periodicity.

5. The UE of claim 3, wherein the one or more processors are individually or collectively further operable to execute the code to cause the UE to:
refrain from transmitting a second report via one or more time resources of the periodic set of time resources based at least in part on the buffer usage information being the same as buffer usage information included in a previous report, a utilization of the buffer being below a threshold value, the buffer being empty, or a combination thereof.

6. The UE of claim 1, wherein the one or more processors are individually or collectively further operable to execute the code to cause the UE to:
receive, via the transceiver and from the network entity, a message comprising one or more downlink control information bits, wherein the one or more downlink control information bits trigger the UE to transmit the report.

7. The UE of claim 6, wherein the one or more downlink control information bits indicate one or more priority values, one or more component carriers, or a combination thereof, associated with buffer usage information to be included in the report.

8. The UE of claim 1, wherein the one or more processors are individually or collectively further operable to execute the code to cause the UE to:
detect an event at the UE, wherein the report is transmitted based at least in part on detection of the event by the UE.

9. The UE of claim 8, wherein, to detect the event, the one or more processors are individually or collectively operable to execute the code to cause the UE to:
detect an absence of a downlink control information transmission from the network entity.

10. The UE of claim 8, wherein, to transmit the report, the one or more processors are individually or collectively operable to execute the code to cause the UE to:
transmit, via the transceiver, the report based at least in part on a buffer usage satisfying a threshold value, wherein the event comprises the buffer usage satisfying the threshold value.

11. The UE of claim 1, wherein the one or more parameters indicate a transport block associated with the decoding information stored in the buffer.

12. The UE of claim 11, wherein the one or more parameters comprise an indication of a carrier identification value, a hybrid automatic repeat request identification value, a new data indication associated with the downlink message, or a combination thereof.

13. The UE of claim 1, wherein the one or more processors are individually or collectively further operable to execute the code to cause the UE to:
store, in the buffer of the UE, additional decoding information associated with a plurality of decoding operations for a respective plurality of downlink messages, each of the plurality of decoding operations being at least partially unsuccessful.

14. The UE of claim 13, wherein the one or more processors are individually or collectively further operable to execute the code to cause the UE to:
transmit the report indicating the buffer usage information, wherein the buffer usage information indicates one or more parameters of the decoding information associated with the plurality of decoding operations.

15. The UE of claim 13, wherein the buffer usage information comprises a respective bitmap for each component carrier of a set of component carriers associated with the plurality of downlink messages, each respective bit of a first bitmap for a first component carrier of the set of component carriers indicating whether decoding information associated with a respective transport block for a respective downlink message of the plurality of downlink messages is stored in the buffer.

16. The UE of claim 1, wherein the buffer usage information indicates a time instance, the time instance indicating that decoding information associated with downlink messages transmitted after the time instance is stored in the buffer and decoding information associated with at least one downlink message transmitted before the time instance is purged from the buffer.

17. The UE of claim 1, wherein the report is transmitted via an uplink control information message.

18. The UE of claim 17, wherein the one or more processors are individually or collectively further operable to execute the code to cause the UE to:
transmit, via the transceiver, a first uplink control information message indicating a size of the report; and
transmit, via the transceiver, a second uplink control information message including the report.

19. The UE of claim 1, wherein the report is transmitted via a medium access control-control element message.

20. A network entity, comprising:
one or more memories storing processor-executable code; and
one or more processors coupled with the one or more memories and individually or collectively operable to execute the code to cause the network entity to:
transmit a downlink message to a user equipment (UE);
receive, from the UE, a report indicating buffer usage information of a buffer of the UE, wherein the buffer usage information indicates one or more parameters of decoding information associated with at least a partially unsuccessful decoding operation of the downlink message at the UE; and
transmit a retransmission of the downlink message based at least in part on receiving the report.

21. The network entity of claim 20, wherein the decoding information comprises one or more log-likelihood ratios for a transport block associated with the downlink message.

22. The network entity of claim 20, wherein the one or more processors are individually or collectively further operable to execute the code to cause the network entity to:
transmit a message indicating a periodic set of time resources for transmission of the report by the UE in accordance with a periodicity, wherein the report is received via a one or more resources of the periodic set of time resources in accordance with the periodicity.

23. The network entity of claim 20, wherein the one or more processors are individually or collectively further operable to execute the code to cause the network entity to:
transmit a message comprising one or more downlink control information bits, wherein the one or more downlink control information bits trigger the UE to transmit the report.

24. The network entity of claim 23, wherein the one or more downlink control information bits indicate one or more priority values, one or more component carriers, or a combination thereof, associated with buffer usage information to be included in the report.

25. The network entity of claim 20, wherein the one or more parameters indicate a transport block associated with the decoding information stored in the buffer.

26. The network entity of claim 25, wherein the one or more parameters comprise an indication of a carrier identification value, a hybrid automatic repeat request identification value, a new data indication associated with the downlink message, or a combination thereof.

27. The network entity of claim 20, wherein, to receive the report, the one or more processors are individually or collectively further operable to execute the code to cause the network entity to:
receive the report indicating the buffer usage information, wherein the buffer usage information indicates one or more parameters of additional decoding information associated with a plurality of decoding operations corresponding to a plurality of downlink messages, each of the plurality of decoding operations being at least partially unsuccessful.

28. The network entity of claim 27, wherein the buffer usage information comprises a respective bitmap for each component carrier of a set of component carriers associated with the plurality of downlink messages, each respective bit of a first bitmap for a first component carrier of the set of component carriers indicating whether decoding information associated with a respective transport block for a respective downlink message of the plurality of downlink messages is stored in the buffer.

29. A method for wireless communications by a user equipment (UE), comprising:
performing a decoding operation on a downlink message for the UE;
storing, in a buffer of the UE, decoding information associated with the decoding operation on the downlink message based at least in part on the decoding operation on the downlink message being at least partially unsuccessful; and
transmitting, to a network entity, a report indicating buffer usage information of the buffer of the UE, wherein the buffer usage information indicates one or more parameters associated with the decoding information stored in the buffer of the UE.

30. A method for wireless communication by a network entity, comprising:
transmitting a downlink message to a user equipment (UE);
receiving, from the UE, a report indicating buffer usage information of a buffer of the UE, wherein the buffer usage information indicates one or more parameters of decoding information associated with at least a partially unsuccessful decoding operation of the downlink message at the UE; and
transmitting a retransmission of the downlink message based at least in part on receiving the report.
